(19) United States
(12) Patent Application Publication
(10) Pub. No.: US 2020/0265145 A1
(43) Pub. Date: Aug. 20, 2020

(54) METHOD AND SYSTEM FOR PROVIDING A SCANNING APPLIANCE TO IDENTIFY SECURITY RISKS AND VULNERABILITIES IN SOFTWARE DESIGN PRIOR TO THE SOFTWARE'S IMPLEMENTATION

(71) Applicant: NUCLEAUS LLC, Raleigh, NC (US)

(72) Inventors: Dimitry Slabyak, Raleigh, NC (US); David Giambruno, Wake Forest, NC (US); Max Slabyak, Colts Neck, NJ (US); David Murray, Tierra Verde, FL (US); Jerome Schulist, Oviedo, FL (US); Robert Rothermel, Sugar Notch, PA (US)

(21) Appl. No.: 16/791,351

(22) Filed: Feb. 14, 2020

Related U.S. Application Data
(60) Provisional application No. 62/806,537, filed on Feb. 15, 2019.

(51) Int. Cl. G06F 21/57; G06F 30/20; G06F 8/70

(52) U.S. Cl. CPC G06F 21/577; G06F 8/70; G06F 30/20

(57) ABSTRACT

Disclosed herein is a method and system using either dedicated appliances or virtual hosts to perform scanning on software repositories to identify malware and security risks in the software coding design prior to production implementations. The system can be utilized to provide a preemptive measure to ensure best practices are employed. The system can also scan for common errors such as hardcoded passwords to ensure they are not introduced in the implementation of the software. The system can also be used to automatically provide a layer defense in a Software Development Lifecycle for detection during testing and quality assurance phases.

### CROSS-REFERENCE TO RELATED APPLICATIONS

This application claims priority to U.S. Provisional Application Ser. No. 62/806,537, filed Feb. 15, 2019, the entire contents of which are hereby incorporated by reference in their entirety.

### FIELD OF THE INVENTION

The present invention relates generally to an automated security tool used as part of the software development lifecycle process during software authoring and design to identify security risks and vulnerability.

### BACKGROUND

Computing devices and the associated software have become commonplace in developed societies in almost every activity performed throughout the day. Recently, even home appliances (e.g., refrigerators, washers, driers, etc.) and other devices have been networked in the iOT (Internet of Things). Users are now constantly connected and networked through wide-area public networks, internal, and external public networking. The users and their associated devices have wide access to each other through these vast conduits.

Unfortunately, this broad connectivity provides a window for malicious entities to attack computing and networking systems and once compromised become an avenue for malicious activities. A common but not always considered method for the “door and windows” of computing networks to be open is not taking diligence and deliberate care while authoring/designing software code to run on computing and network appliance devices. There are several factors that influence the lack of such care including time and environmental constraints, laborious manual processes, and simply general human skill levels that make up software engineering communities as well as modern software utilizes “sub packages” or commonly called libraries written by others. To compound these deficiencies, the rate of security attacks is ever increasing and without automation it is impossible to keep up with malware sophistication. Previous solutions address Security Risks and Vulnerabilities after they are present and in many cases in production environments introducing further risk. Therefore, a need exists for a system or method capable of detecting these security risks and vulnerabilities prior to software deployment so that users are not adversely affected by any malware.

### SUMMARY

The present invention comprises a scanning system and sub-system for detecting security risks and vulnerabilities in software. The software utilized to embody the present invention may be run locally (e.g., on a server) or deployed in a virtual computing environment that is implemented as a Platform as a Service (PaaS) to scan computing software repositories. As part of the scanning, these software repositories are simulated as run-time execution routines to evaluate the software code for security vulnerabilities as if they were implemented in working software code. This provides an advantage in that it evaluates security risks and vulnerabilities present in real world environments that may not be apparent through standard code scanning or review. Once a vulnerability signature is determined, the system reports the vulnerabilities in real-time to the user/reviewer, similar to how a spell checker alerts a user. Once security vulnerabilities are found, they are ranked and categorized using a communal vulnerability signature database for presentation to the software code author so that they may be addressed.

The system of the present invention further offers risk remediation services to the software author to automatically address or remove the security vulnerabilities or malware. This allows even a user that may not have the required experience to understand and/or fix the vulnerabilities. The invention's algorithms use inputs from the feedback of all the users making the system grow in intelligence as more users are added building these remediations.

### BRIEF DESCRIPTION OF THE DRAWINGS

FIG. 1 depicts a flowchart showing the steps utilized to detect, classify, and remediate vulnerabilities in software code.

FIG. 2 depicts how the system of the present invention is integrated into normal software development lifecycle practices so that when the software engineers engage normal workflows, the invention provides as an automated security mechanism.

FIG. 3 depicts a system architecture explaining how version segmentation of software can be addressed in eCommerce platforms.

FIG. 4 depicts the typical code structure that multi-tenant users may implement.

FIG. 5 depicts how crowdsourced software code authors can use the invention to qualify the security of the final product, thus releasing payment for the work.

FIG. 6 depicts examples of how roles based access would be applied to the team implementation approach

FIG. 7 depicts rule based access control (RBAC) data model architecture.

### DETAILED DESCRIPTION OF THE INVENTION

The invention as described is implemented as either an appliance or virtual computing environment that scans computing software code and it very nature is a democratized approach to a complex problem whereby it ranks highest to lowest percentage of vulnerabilities in computing software code as it is authored and applied in a SDLC (software development lifecycle) phase prior to the Quality Assurance gate and compilation into a run-time environment. At its simplest, the invention can be analogized to how a document's spellcheck functions so that the authors can see potential risks prior to the release of their software code into production repository branches. Also, because computational software code can be authored multiple ways that lead to the same resulting run-time executable instructions, this code is written allows for a high, low or somewhere in between when evaluated it from a security perspective.

The inventions allows scanning during code development to see if the “doors and windows are closed and locked” using “fingerprint scanning art.” The invention is defined through this signature scanning and the ability to preempt vulnerabilities from a security hygiene perspective prior to production run-time. Another aspect of this invention is that it outputs resulting visibility of the code scans into standards based National Institute of Standards and Technology (NIST) and OWASP, the Open Web Application Security Project categorization which gives the designing software engineers a better understanding and assessment of the levels, impacts, and remediations of potential vulnerabilities. When aligned with NIST/OWASP standards, there is a higher degree of Communal and Government conformance for remediating the potential malicious activities.

Another aspect of the invention, which is unique, is that most computing software relies on libraries which are modules written and distributed by others to perform specific tasks. The invention scanning includes those software libraries, to alert the software code author of vulnerabilities not part of their work, which are dependencies of the final product.

The invention starts with a computing software code scanner in a virtual computing environment or a computing appliance. Its components, formed in a tiered modular software structure, are:

Database Tier which contains; A) The tenant ID which segments the work zone for the invention to operate; B) The initial instruction set for the configurations of the specific tenant's computing and networking environments; C) The Roles Based Access and Controls specifications necessary to comply with the tenants needs; D) The invention's software code seeding needed to initiate the invention's executable application tier; E) Specifics variables and metadata to identify the workflow characteristics; F) The Communal Security Knowledge Base store captured from the Communal aggregation tier; G) The Artificial Intelligence Store captured by the AI tier; H) The raw data output from the scanning device structured by vulnerability.

Application Tier which contains; A) Scanning Engine—The executable computing instruction set for software code Scanning tier; B) Communal Aggregation Engine—The executable computing instruction set for the Communal Security Knowledge Base gathering; C) Artificial Intelligence Engine—The executable computing instruction set that contains the learning algorithms; D) The Metadata and Taxonomy Engine—The executable computing instruction set that captures and structures context data about the scans being executed; E) The Results Engine—The executable computing instruction set that displays the results to the UI; F) The Alerts/Triggers Engine—The executable computing instruction set that gives warnings based on predefined event triggers and; G) The Remediation Engine—Uses contextual properties of the results engine to guide more secure remediation suggestions to the users.

User Interface Tier which contains the visual display of the resulting output from applications tiers in multiple formats including; A) Web; B) Mobile; C) Small Compute format and; D) IoT types of formats.

Service Tier which contains the extensibility features such as;) Integrations and workflows into eCommerce platforms; B) Integrations into Identity Management platforms (SSO); and C) Application Platform Interfacing of the invention

The invention tests the authored software code within the software code's repository against a set of generally accepted security classifications such as common weakness enumeration (CWE), Common Vulnerabilities Exposures (CVE), and Common Vulnerability Scoring System (CVSS). These vulnerabilities are then augmented with metadata from the vendor-agnostic industry standard frameworks, which allows the invention to prioritization and display to the user the urgency and priority of response using the inventions remediation knowledge base engine (KBE). This problem/solution architecture is another key aspect of the invention.

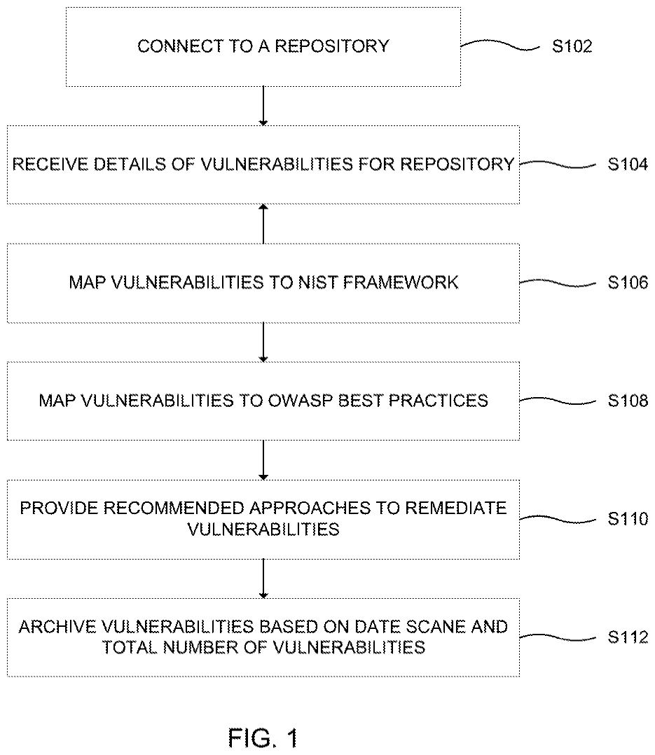

Referring first to FIG. 1, depicted is a flowchart showing the steps to detect, classify, and remediate vulnerabilities in software code according to an embodiment of the present invention. First, the system 100 of the present invention connected to a code repository in S102. The code repository preferably is used to store the code for all projects during development of any software or platforms. The system 100 then determines and receives details of vulnerabilities for the code repository in S104. The vulnerabilities can be selected from a preexisiting list of known vulnerabilities or those determined from user reports.

In S106, the vulnerabilities are mapped to the National Institute of Standards and Technology (NIST) framework. NIST maintains a framework for improving critical infrastructure cybersecurity which enables organizations to apply the principles and best practices of risk management to improving security and resilience. Using the framework, the organization can determine gaps in cybsersecurity risk that may be cause by code in the repository.

The vulnerabilities are also mapped to the Open Web Application Security Project (OWASP) best practices in step 108. This allows organizations to identify which, if any, aspects of the code are not in compliance with OWASP best practices.

The vulnerabilities can be combined to determine an overall Risk Score which provides the developer with a more accurate overall picture about the risks associated with the vulnerabilities. The Risk Score can simply be a tabulation which adds together the number of vulnerabilities or may be a weighted sum, with each different vulnerability assigned a different score based on severity or other factors.

The system 100 of the present invention retains the ability to provide recommendations to users to remedy the vulnerabilities identified in S106 and S108. The recommendations develop over time as the effectiveness of previous recommendations are validated by different organizations. This enables system 100 to provide current and effect recommendation for remedying vulnerabilities in S110.

Further, in order to maintain proper records and to ensure that the same vulnerabilities are not repeated in future code, the system 100 archives the vulnerabilities in S112 based on date and the total number of vulnerabilities present on the date. This information also lets system 100 determine which types of vulnerabilities are most prevalent in the repositories and helps to better tailor the recommendations that are provided in S110.

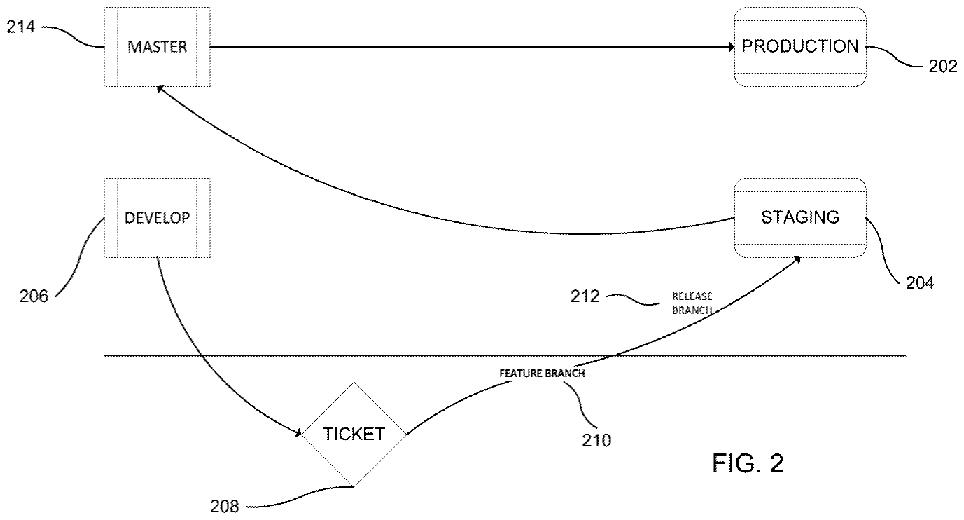

FIG. 2 depicts how the system of the present invention can be integrated into normal development lifecycle practices to provide an automated security mechanism which functions utilizing the workflow of FIG. 1. As code is developed at develop branch 206, any changes to the code are branched off and assigned a JIRA ticket 208. JIRA is a proprietary issue tracking product developed by Atlassian® that allows bug tracking. It should be obvious that any issue tracking product can be substituted for JIRA. The new branch name assigned by system 100 started with the ID of JIRA ticket 208.

The master branch 214 reflects the state of the production servers (i.e., the code for production). Code pushed to master branch 214 is eventually pushed to production branch 202 automatically. Therefore, any commits from master branch 214 that merge into master ranch 214 require approval.

Feature branches 210 must branch from the develop branch 206 and be named for the JIRA ticket 208 that created the work. The code from each feature branch 210 is tested at staging branch 204. Once approved at the staging branch 204, the JIRA ticket 208 is closed and the code in incorporated into master branch 214.

Preferably, the workflow depicted in FIG. 1 occurs at staging branch 204 to allow all code vulnerabilities to be identified as features are received from feature branch 210. Because each feature branch 210 is identified by a unique JIRA ticket 208, the system 100 allows easy identification of which code from feature branch 210 caused any identified vulnerabilities.

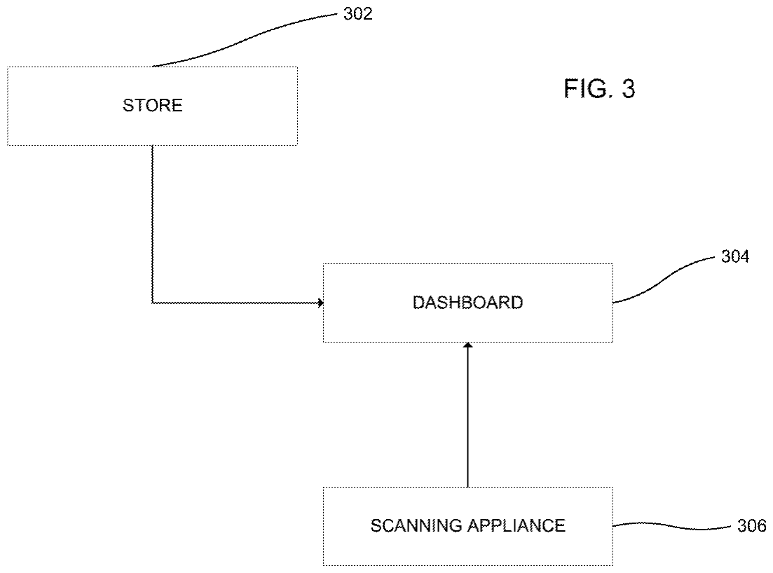

FIG. 3 depicts a system architecture explaining how version segmentation of software can be addressed in eCommerce platforms. eCommerce platforms generally comprise a store 302 which serves as an interface with the customer (e.g., via Shopify) and an inventory management system managed by a database at dashboard 304. Scanning appliance 306, implementing the workflow of FIG. 1, interfaces with dashboard 304. The scanning appliance 306 is developed per organization and interfaces with the unique products used for store 302 and dashboard 304. Specifically, certain parts of both store 302 and dashboard 304 require regression testing.

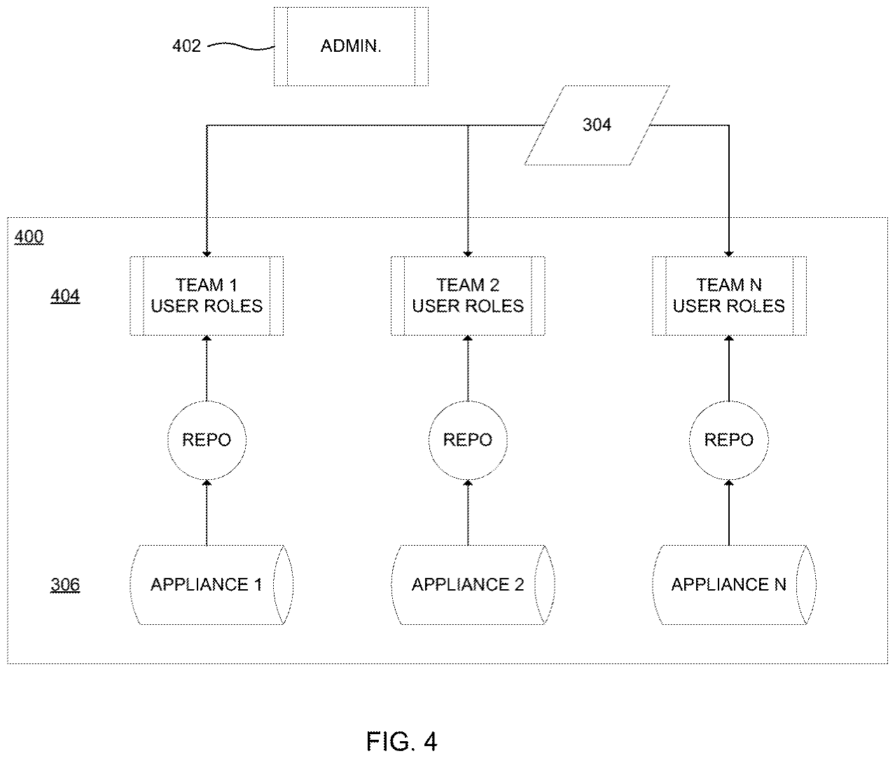

FIG. 4 depicts a system architecture 400 in which can accommodate multi-tenant organizations. An administrator 402 can manage teams of multiple users 404 that are developing code. Each team 404 is responsible for developing different aspects (e.g., of an e-Commerce platform). A different scanning appliance 306 is provided for each team that is tailored to the different type of coding being done by the team. That is, each team 404 utilizes the code development platform of FIG. 2 and vulnerabilities in the code are identified using the workflow of FIG. 1. This allows the administrator to independently monitor each team 404 and the different vulnerabilities that are identified for each team 404.

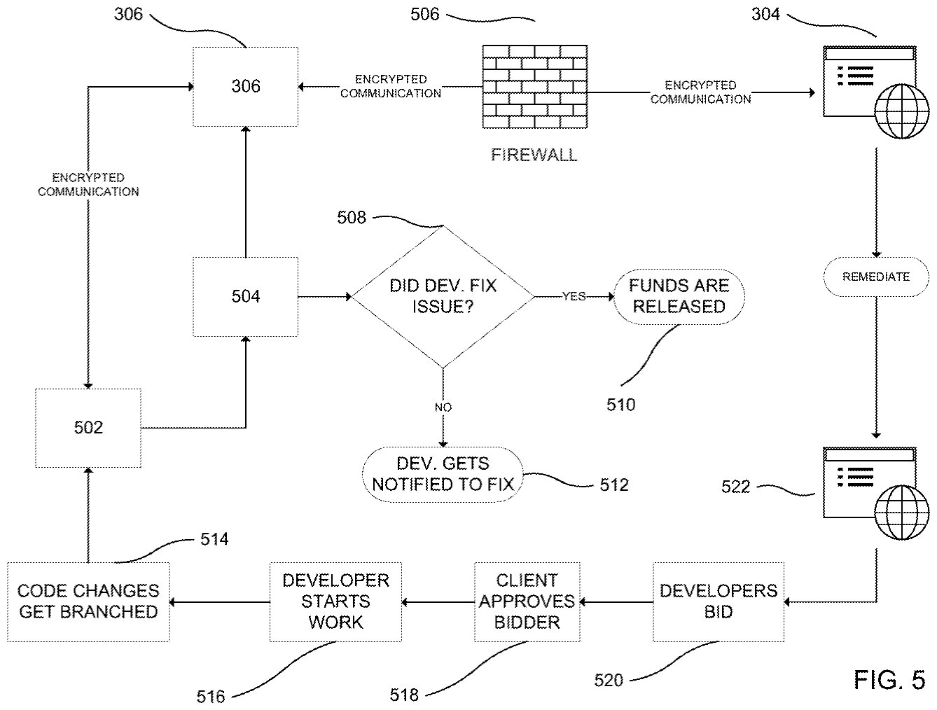

FIG. 5 depicts how crowd sourced code authors can use the system of the present invention to qualify the security of the final product. The code for the product is stored in repository 502. The appliance 306 communicates and scans the code through encrypted communication in 504. The scanning by appliance 306 all occurs behind firewall 506. Vulnerabilities are communicated to an administrator via dashboard 304. As code changes are made in response to the vulnerabilities, they are branched at 514 using the development architecture depicted in FIG. 2.

As vulnerabilities are identified at the dashboard 304, remediation must occur. Developers 520 can bid on remediation and the client 518 can approve the bidder. Once the bid is approved, the developer 516 starts the coding to address the vulnerabilities. After the new code from the developer 516 has been added to the repository 502, scanning appliance 306 verifies that the vulnerabilities have been address in 508. If so, the funds are released to the developer 516 in step 510. If not, a message 512 is sent to the developer 516 that additional changes to the code are needed to address vulnerabilities. Using this workflow, scanning appliance 306 can be used to ensure that all vulnerabilities in the code have been addressed before releasing the funds to developer 516. Also, because the coding is done behind firewall 506, the developer 516 is protected from any external threats.

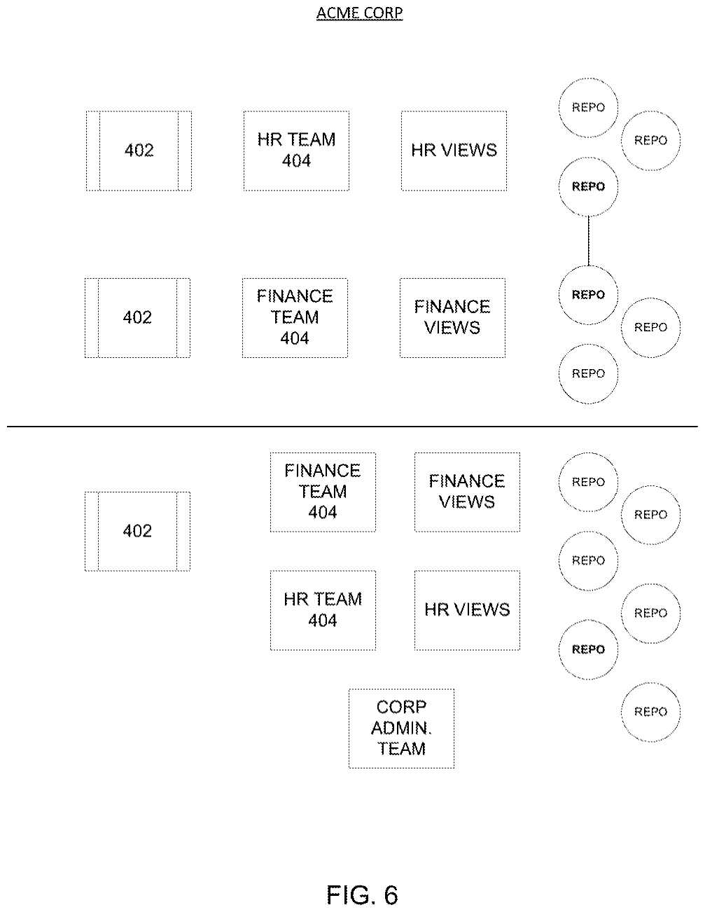

FIG. 6 depicts a sample of teams 404, with each team 404 having a separate administrator 402. In this example, each team 404 has a different administrator 402 responsible for ensuring that the team 404 is functioning properly.

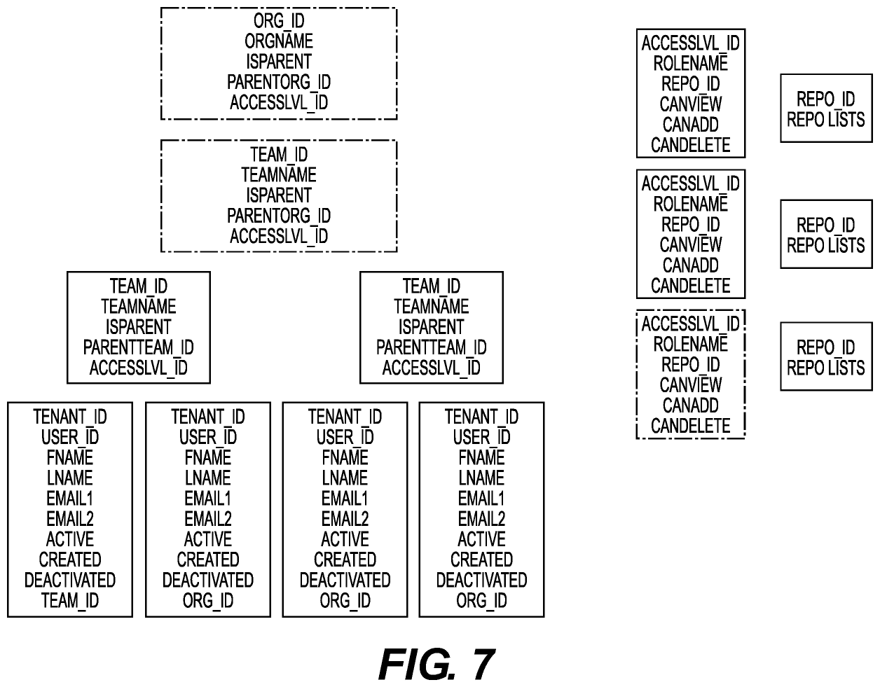

FIG. 7 depicts a rule based access control (RBAC) data model architecture 700.

1. A method for a Compute Security Risk and Vulnerabilities analysis comprising:
a. scanning software source code repositories prior to implementation of the software source code in a production environment;
b. identifying vulnerabilities in software designs by simulation of the software source code at runtime;
c. developing a Risk Score in accordance with recognized cyber security standards and best practice standards; and
d. providing recommendations on mitigation or remediation of the vulnerabilities based on the constraints and priority of the risk categorization.

2. A Computing Device for implementing a Compute and Networking Appliance Security Risk and Vulnerabilities analysis comprising:
a. a processor;
b. a computer storage medium coupled to the processor;
c. software instructions sets executed in accordance to the method described in claims 1 and 2;
d. a reporting mechanism to display results sets from the software source code scans; and
e. an Alerting mechanism to send off alerts based on predefined instruction criteria and thresholds.

3. The method of claim 1, wherein there is security risk associated with use of the software in a production environment.

4. The method of claim 1, wherein users set software scans intervals for the software source code repositories.

5. The method of claim 1, wherein recognized cyber security standards are the National Institute of Standards and Technology (NIST) Framework.
